(19) United States
(12) Patent Application Publication
(10) Pub. No.: US 2026/0097656 A1
(43) Pub. Date: Apr. 9, 2026

(54) CONTEXT-AWARE FUNCTIONALITY FOR VEHICLES

(71) Applicant: QUALCOMM Incorporated, San Diego, CA (US)

(72) Inventors: Sunvir GUJRAL, San Diego, CA (US); Jonathan KIES, Encinitas, CA (US); Stanislaus KADUGAMPARAMBIL, Lafayette, CO (US)

(21) Appl. No.: 19/352,362

(22) Filed: Oct. 7, 2025

Related U.S. Application Data
(60) Provisional application No. 63/705,384, filed on Oct. 9, 2024.

(51) Int. Cl. B60K 35/29; B60K 35/10; B60W 40/08; B60W 40/09

(52) U.S. Cl. CPC B60K 35/29; B60K 35/10; B60W 40/09; B60K 2360/11; B60W 2040/0818

(57) ABSTRACT

Systems and techniques are described herein for a context-aware intelligent cockpit. For example, a computing device can capture, using a plurality of sensors, context data associated with user operation of a vehicle. The computing device can determine a distraction score based on the context data. The computing device can adjust a user interface of the vehicle based on the distraction score.

### CROSS-REFERENCE TO RELATED APPLICATIONS

This application claims the benefit of U.S. Provisional Application No. 63/705,384, filed Oct. 9, 2024, which is hereby incorporated by reference in its entirety and for all purposes.

### FIELD

The present disclosure generally relates to an adaptable vehicle cockpit. For example, aspects of the present disclosure relate to a context-aware (e.g., sensor-based context) functionality for vehicles (e.g., a context-aware intelligent cockpit for vehicles).

### BACKGROUND

Driver distraction and driver fatigue are among the most common causes for automobile accidents. For example, many crashes are caused by drivers distracted by smartphones and other devices. Safety issues stemming from distracted driving are further compounded by the addition of more screens to vehicles, such as screens for controlling functions of the vehicle. Increased interconnectivity between mobile devices (e.g., smartphones, tablet computers, etc.) and vehicles further adds distractions to drivers. Further, many drivers underestimate the effects of fatigue on driving abilities and driver attention. The increased attention of user to mobile devices and/or other devices, to interface(s) within a vehicle, driver fatigue, and/or other distractions can result in less attention to operating vehicles presenting a safety concern for other drivers and passengers.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for context-aware driving assistance is provided. The apparatus includes at least one memory and at least one processor coupled to the at least one memory. The at least one processor is configured to: capture, using a plurality of sensors, context data associated with user operation of a vehicle; determine a distraction score based on the context data; and adjust a user interface of the vehicle based on the distraction score.

In some aspects, a method for context-aware driving assistance is provided. The method can include: capturing, using a plurality of sensors, context data associated with user operation of a vehicle; determining a distraction score based on the context data; and adjusting a user interface of the vehicle based on the distraction score.

In some aspects, a non-transitory computer-readable medium is provided having stored thereon instructions that, when executed by at least one processor, cause the at least one processor to: capture, using a plurality of sensors, context data associated with user operation of a vehicle; determine a distraction score based on the context data; and adjust a user interface of the vehicle based on the distraction score.

In some aspects, an apparatus for context-aware driving assistance is provided. The at least one processor is configured to: means for capturing, using a plurality of sensors, context data associated with user operation of a vehicle; means for determining a distraction score based on the context data; and means for adjusting a user interface of the vehicle based on the distraction score.

In some aspects, an apparatus for context-aware driving assistance is provided. The apparatus includes at least one memory and at least one processor coupled to the at least one memory. The at least one processor is configured to: capture, using a plurality of sensors, driver data associated with user operation of a vehicle; and determine, based on the driver data, an action to perform.

In some aspects, a method for context-aware driving assistance is provided. The method can include: capturing, using a plurality of sensors, driver data associated with user operation of a vehicle; and determining, based on the driver data, an action to perform.

In some aspects, a non-transitory computer-readable medium is provided having stored thereon instructions that, when executed by at least one processor, cause the at least one processor to: capture, using a plurality of sensors, driver data associated with user operation of a vehicle; and determine, based on the driver data, an action to perform.

In some aspects, an apparatus for context-aware driving assistance is provided. The at least one processor is configured to: means for capturing, using a plurality of sensors, driver data associated with user operation of a vehicle; and means for determining, based on the driver data, an action to perform.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

FIG. 1 illustrates an example implementation of a neural network using a system-on-a-chip (SOC), including a general-purpose processor, according to various aspects of the present disclosure;

FIGS. 2A, 2B, and 2C are diagrams illustrating a neural network, according to various aspects of the present disclosure;

FIG. 3 is a block diagram illustrating an exemplary deep convolutional network (DCN), according to various aspects of the present disclosure;

FIG. 4 is a block diagram of an example transformer in accordance with some aspects of the disclosure;

FIG. 5 is a diagram illustrating an example of a vehicle with a sensor suite, according to various aspects of the present disclosure;

FIG. 6 is a block diagram illustrating an example of a process for providing a context-aware intelligent cockpit system.

FIG. 7 is a block diagram illustrating an example context-aware intelligent cockpit system.

FIGS. 8A and 8B are block diagrams representing a user interface of a vehicle adjusted by the context-aware intelligent cockpit system.

FIG. 9 is a flow diagram for an example process for adjusting a user interface of a context-aware intelligent cockpit system, in accordance with aspects of the present disclosure.

FIG. 10 is a flow diagram for example process for performing actions responsive to driver operation of a vehicle using a context-aware intelligent cockpit system, in accordance with aspects of the present disclosure.

FIG. 11 is a block diagram illustrating an example computing-device architecture of an example computing device which can implement the various techniques described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As mentioned previously, driver distraction and driver fatigue are among the most common causes for automobile accidents. Many crashes are caused by drivers distracted by smartphones and/or other electronic devices, by interface(s) within a vehicle, etc. Many drivers underestimate the effects of fatigue on driving abilities and attention retention. Increased attention to electronic devices, vehicle interfaces, driver fatigue, among other distractions results in less driver attention to operating vehicles presenting safety concerns for other drivers and passengers.

Driver safety can be improved by the integration of advanced car sensors, such as sensors used in providing advanced driver assistance systems (ADAS) to assist drivers when operating a vehicle. Sensors can be used to capture information associated with the driver, operation of the vehicle, and the environment in which the vehicle is operating. For example, vehicles can include microphones and cameras located within the cockpit of the vehicle to capture information associated with the driver, such as voice commands, gestures, etc. Further, many vehicles include cameras, Light Detection and Ranging (LIDAR) sensors, radio detection and ranging (RADAR) sensors, etc. located outside of the vehicle to capture information associated with the environment. For example, many vehicles include various sensors to identify other vehicles in the environment, detect obstacles, identify traffic signs, etc. In further examples, the vehicle can use sensors to determine weather (e.g., cameras to identify rain, barometer to identify storms, etc.). In some examples, the vehicle can receive data associated with the weather from a device or application (e.g., receiving weather data from a smartphone or weather application). In another example, the vehicle can receive historical and demographic data associated with a driver. For example, the driver can have a driver profile associated with his or her phone. When the driver pairs his or her phone with the vehicle, or the vehicle detects the phone of the driver, the vehicle can receive historical driving data (e.g., driving preferences, driving history such as history of safe or unsafe driving, etc.) and demographic data (e.g., driver age, gender, physical capabilities, cognitive capabilities, etc.).

The amount of attention a driver must focus on driving to safely operate a vehicle can vary based on events and conditions occurring in the environment the vehicle is operating. For example, a driver driving in heavy traffic must focus more of his or her attention on driving than a driver driving on an empty road. In another example, a driver operating a vehicle during adverse weather conditions (e.g., driving in rain, sleet, icy conditions, etc.) must focus more of his or her attention on driving as opposed to a driver during clear conditions. For example, a brief interaction with a user interface to adjust a music playlist can be a largely benign action when performed by a driver operating a vehicle on a clear road but could be an unsafe action when performed by a driver operating a vehicle during a thunderstorm. Current ADAS and other driving assistance systems fail to account for the context in which a vehicle is operating (e.g., conditions internal and external to the vehicle) when determining whether actions performed by a driver are safe.

Systems, apparatuses, electronic devices, methods (also referred to as processes), and computer-readable media (collectively referred to herein as “systems and techniques”) are described herein for providing a context-aware intelligent cockpit. For instance, the context-aware intelligent cockpit can provide a context-aware (e.g., sensor-based context) feedback and functionality for vehicles (e.g., a context-aware intelligent cockpit for vehicles). In some aspects, the context-aware intelligent cockpit includes various sensors within an interior of a vehicle to capture information associated with a user (e.g., a driver) and information associated with operation of the vehicle. In further aspects, the context-aware intelligent cockpit can receive various sensor data and perform actions based on the sensor data. For example, the context-aware intelligent cockpit can receive various data from sensors located interior or exterior to the cockpit. The context-aware intelligent cockpit can process the sensor data and perform actions based on the sensor data. In further aspects, the context-aware intelligent cockpit can process the sensor data using a machine learning model or algorithm to generate scores associated with the sensor data (e.g., a driver distraction score, driver condition score, drive condition score, a vehicle condition score, etc.). The context-aware intelligent cockpit can perform actions or generate recommendations to perform actions based on the score. In some aspects, the scores can be provided to applications or subsystems of a vehicle to perform actions based on the scores.

In some aspects, the context-aware intelligent cockpit can perform actions such as adjusting a user interface of the vehicle. For example, the vehicle can include a display with a user interface for selecting various actions or functions to be performed by the vehicle or various subsystems of the vehicle (e.g., air conditioning A/C, multimedia system, speakers, lights, ADAS, etc.). The context-aware intelligent cockpit can limit actions performed by the vehicle and the various subsystems based on the scores. For example, the context-aware intelligent cockpit can gray out or remove elements associated with functions disabled by the context-aware intelligent cockpit. For example, when the driver distraction score exceeds a distraction threshold, the context-aware intelligent cockpit can limit actions such as adjusting music, typing navigation requests on a global positioning system (GPS) (or global navigation satellite system (GNSS)), placing calls on cell phone, etc.

In further aspects, the context-aware intelligent cockpit can display the driver distraction score on a display, dashboard, or other screen of the vehicle. The driver distraction score can be represented on a graphical meter. The graphical meter can increase as the driver distraction score increases. For example, the graphical meter can be an analog dial, bar chart, or other meter which can rise as the driver distraction score. The graphical meter can show the driver distraction score increasing as various sensors and vehicle subsystems show increased activity. In some examples, a screen can display alerts to redirect driver attention to the road when the driver distraction score exceeds a distraction threshold.

In some aspects, the user interface can alert a driver that the driver is distracted by adjusting themes (e.g., changing in color, limiting available functions such as disabling a music application, etc.) or layout of the user interface when the driver distraction score exceeds the distraction threshold. For example, the user interface can flash a light (e.g., a yellow or red warning light) and display a prompt such as “FOCUS NEEDED”. In some examples, the context-aware intelligent cockpit can output the prompt as audio using speakers of the vehicle.

In further aspects, the context-aware intelligent cockpit can generate a prompt associated with the context (as captured by the various sensors) in which the vehicle is operating. For example, various sensors of the vehicle can detect the vehicle is operating during a thunderstorm. Various sensors in the interior of the vehicle can detect that the driver is distracted by searching for music based on the driver interacting with a user interface. In such an example, the context-aware intelligent cockpit can generate a prompt indicating the dangers of operating the vehicle in the current weather conditions. For example, the context-aware intelligent cockpit can generate a prompt such as “ROAD CONDITIONS ARE WET—FOCUS NEEDED”. In another example, the context-aware intelligent cockpit can detect traffic conditions or receive information associated with traffic from a device or service (e.g., an HD map, traffic map, other vehicles, etc.). The context-aware intelligent cockpit can generate a prompt such as “TRAFFIC DETECTED—FOCUS ON THE ROAD”.

An HD map may include a high level of detail (e.g., including centimeter level details). In the context of HD maps, the term “high” typically refers to the level of detail and accuracy of the map data. In some cases, an HD map may have a higher spatial resolution and/or level of detail as compared to a non-HD map (also referred to as a standard definition (SD) map). For example, an HD map can provide for lane level precision, while an SD map may provide for road level precision.

While there is no specific universally accepted quantitative threshold to define “high” in HD maps, several factors contribute to the characterization of the quality and level of detail of an HD map. Some key aspects considered in evaluating the “high” quality of an HD map include resolution, geometric accuracy, semantic information, dynamic data, and coverage. With regard to resolution, HD maps generally have a high spatial resolution, meaning they provide detailed information about the environment. The resolution can be measured in terms of meters per pixel or pixels per meter, indicating the level of detail captured in the map. With regard to geometric accuracy, an accurate representation of road geometry, lane boundaries, and other features can be important in an HD map. High-quality HD maps strive for precise alignment and positioning of objects in the real world. Geometric accuracy is often quantified using metrics such as root mean square error (RMSE) or positional accuracy. With regard to semantic information, HD maps include not only geometric data but also semantic information about the environment. This may include lane-level information, traffic signs, traffic signals, road markings, building footprints, and more. The richness and completeness of the semantic information contribute to the level of detail in the map. With regard to dynamic data, some HD maps incorporate real-time or near real-time updates to capture dynamic elements such as traffic flow, road closures, construction zones, and temporary changes. The frequency and accuracy of dynamic updates can affect the quality of the HD map. With regard to coverage, the extent of coverage provided by an HD map is another important factor. Coverage refers to the geographical area covered by the map. An HD map can cover a significant portion of a city, region, or country. In general, an HD map may exhibit a rich level of detail, accurate representation of the environment, and extensive coverage.

For a vehicle (e.g., an autonomous or semi-autonomous vehicle) to utilize HD maps, the vehicle must determine its own position (location) in relation to the HD map. An autonomous vehicle typically utilizes positioning sensors implemented onboard the vehicle to estimate a location of the vehicle. These positioning sensors can include satellite receivers (e.g., for satellite positioning systems) and inertial measurement units (IMUs).

In some aspects, the prompts described above can include additional detail or adjust in emphasis (e.g., tone) based on the driver distraction score. For example, the prompt can be “Please concentrate on the road due to the high traffic, numerous curves, and your frequent glances downwards and excessive use of the display” and “Could you kindly focus more on driving, considering the busy traffic and winding road, as well as your frequent interactions with the display? Thank you” when the driver distraction score exceeds the distraction threshold. In another example, the prompt can be “Focus on the road now! The traffic is heavy, the road is winding, and you're interacting with the display too much!” when the driver distraction score exceeds the distraction threshold. The added emphasis can be based on an extent to which the driver distraction score exceeds the distraction threshold. For example, when the driver distraction score exceeds the distraction threshold by an amount greater than an emphasis trigger, the prompt can include added emphasis. In some aspects, the context-aware intelligent cockpit can include multiple distraction thresholds (e.g., a first distraction threshold associated with generating more patient or polite tone of the prompts, and a second distraction threshold associated with more emphasized tone or direct prompts). In some examples, the context-aware intelligent cockpit can use a machine learning model, such as a large language model (LLM) to generate the prompt. In some examples, the context-aware intelligent cockpit can use the LLM to tailor the speech to more effectively resonate with a user. For example, the LLM can be trained to generate prompts for a target user such as by using tone and cadence consistent with speech patterns of the target user and prompts determined to be effective for the target driver.

In some aspects, the context-aware intelligent cockpit can use various sensors interior to the vehicle to detect driver drowsiness. For example, the vehicle can include cameras to detect user movements and facial expressions. For example, the context-aware intelligent cockpit can use various sensors to identify when the driver closes his or her eyes, yawns, or makes a facial expression indicative of being drowsy. In some aspects, the context-aware intelligent cockpit can perform various actions in response to detecting the driver is drowsy. For example, the context-aware intelligent cockpit can modify the user interface to output an alert audio (e.g., an alarm) and adjust lighting within vehicle. In another example, the context-aware intelligent cockpit can turn on A/C to decrease the temperature in the vehicle.

In another aspect, the context-aware intelligent cockpit can identify a driver based on biometric data (e.g., a facial scan or voice recording) and determine actions to perform based on the identity of the driver. For example, a vehicle can have a primary driver with access to functions restricted for a secondary driver. In some examples, the context-aware intelligent cockpit can perform actions based on the identity of the driver. For example, when the primary driver is distracted, the context-aware intelligent cockpit can generate a warning to the primary driver. When the secondary driver is distracted, the context-aware intelligent cockpit can generate a summary of actions taken by the secondary driver and provide the summary to the primary driver. For example, when the secondary driver is a child of the primary driver, the context-aware intelligent cockpit can warn the primary driver that his or her child (e.g., the secondary driver) are distracted while driving.

In further aspects, the context-aware intelligent cockpit can generate a recommendation based on detecting the driver is drowsy. For example, the context-aware intelligent cockpit can generate a prompt recommending the driver pull over, book a hotel, travel to a particular destination, or order coffee. For example, the context-aware intelligent cockpit can generate a prompt such as “You seem tired, should I find a coffee shop that we can stop at?” The driver can provide input to the user interface or respond in voice to the prompt. For example, the driver can provide an affirmative response (e.g. “Yes, please do”) and the context-aware intelligent cockpit can determine, using a navigation application or GPS, a coffee shop. The context-aware intelligent cockpit, using the navigation application or GPS, can provide navigation instructions or a map directing the driver to the coffee shop. In some examples, the context-aware intelligent cockpit can recommend an updated driving route to assist the driver in remaining alert. For example, the context-aware intelligent cockpit can recommend a route on a winding road or with streetlights to assist the driver in remaining alert as opposed to a straight highway on which the driver might become drowsy.

In some aspects, the context-aware intelligent cockpit can include consumer to consumer (C2C) communication to automatically provide the coffee order of the driver to the coffee shop while the driver is en route to the coffee shop. In some examples, the context-aware intelligent cockpit can receive information from the coffee shop, an application associated with the coffee shop (or other business) to identify a wait time for providing the coffee. In some examples, the context-aware intelligent cockpit can wait to place the order until the vehicle is closer to the coffee shop so that the coffee is not ordered prematurely and cold when the driver arrives. For example, the context-aware intelligent cockpit can receive information indicating the coffee shop has a fifteen-minute wait time. The context-aware intelligent cockpit can wait to provide the order until the vehicle is fifteen minutes away from the coffee shop.

In some aspects, the context-aware intelligent cockpit can use an algorithm and user interface to monitor user (e.g., the driver) distractions and road conditions to generate the driver distraction score. In some examples, the user interface can include an icon providing a live, or near-live, indication of driver distraction. In some examples, the driver distraction score is displayed on the dashboard of the vehicle. When the distraction score exceeds a distraction threshold, the context-aware intelligent cockpit can generate a warning. When the driver does not adjust his or her attention to operating the vehicle, the user interface can restrict driver access to functions and the context-aware intelligent cockpit can generate an additional warning.

In some aspects, the context-aware intelligent cockpit can generate driver distraction scores when the vehicle is put in a driving mode (e.g., put in gear, when the vehicle is in motion, etc.). In some examples, the context-aware intelligent cockpit can stop generating the driver distraction score when the vehicle is parked (e.g., in a parking mode, parking gear, etc.). For example, the context-aware intelligent cockpit can continue generating the driver distraction score when the vehicle is stopped at a red light. The context-aware intelligent cockpit can stop generating driver distraction scores when the vehicle is parked.

In some aspects, the driver distraction score can be a value from 1.0 to 10. In some examples, 1.0 can indicate the driver is attentive to the road and 10 can indicate the driver is highly distracted or incapacitated. The driver distraction score can be generated using sensor data captured on a rolling time window. For example, the driver distraction score can be generated using sensor data from the past ten to fifteen seconds, or other predetermined rolling time period. The driver distraction score can be generated every second using sensor data from the past ten to fifteen seconds. In some examples, the periodicity of the distracted driver score can be adjusted based on the speed of the vehicle or environmental conditions. For example, the distracted driver score can be generated more often (e.g., at a lower periodicity/higher frequency) when the driver is driving over seventy miles per hour, compared to when the driver is driving below twenty miles per hour.

The distracted driver score can be based on various inputs received by the context-aware intelligent cockpit. For example, the distracted driver score can receive inputs from cameras of a driver monitoring system (DMS) and the user interface. In some examples, multipliers can be applied to different inputs based on the context of operation of the vehicle. For example, when the vehicle is operated in heavy traffic or adverse weather conditions, the context-aware intelligent cockpit can weigh information associated with different inputs higher than others. frequency in which the driver interacts with a user interface or display.

The algorithm can use specific inputs influencing the driver distraction score. By way of non-limiting examples, the following are a list of distraction factors associated with a driver that can be used to generate the driver distraction score: looking away from the road, interacting with the car's display (e.g., a count of the number of driver interactions with the display), eating, drinking, smoking, engaging in conversation with a passenger, engaging in conversation on a phone, holding and interacting with a handheld device, listening to a podcast or audio book, engaging with a voice assistant, and a noise level within the vehicle.

The algorithm can apply weights to various distraction factors indicating that actions taken by the driver associated with the distraction factors can vary in how the actions distract the driver. For example, the driver engaging in conversation with a passenger can be less distracting to the driver than interacting with a handheld device (e.g., texting on a smartphone). The weight applied to the distraction factor associated with interacting with a handheld device can have a higher weight than the distraction factor associated with engaging in conversation with the passenger.

In some aspects, the context-aware intelligent cockpit can provide rewards and tokens to encourage focusing on the road when driving. The context-aware intelligent cockpit can award points for focused driving and apply penalties (e.g., take away tokens) based on distracted driving.

In some aspects, the distraction threshold can adjust based on the environment in which the vehicle is operating. The distraction threshold can represent a threshold amount of distraction a driver can experience before being warned that the driver is not safely operating the vehicle. The amount of distraction experienced by the driver is quantified using a distraction algorithm or machine learning model which can process the distraction factors to quantify the level of distraction of the driver, also referred to as the user. The context-aware intelligent cockpit can adjust the distraction threshold based on various threshold factors. The threshold factors can include sensor data associated with the driver, the vehicle, the operation of the vehicle, and the environment in which the vehicle is operating.

By way of non-limiting examples, the following are a list of threshold factors that the context-aware intelligent cockpit can use to adjust the distraction threshold: weather, level of rain, snow, fog; whether the vision of the driver is temporarily impaired by the sun; glare on the windshield; road conditions; width of lanes; whether the road includes a shoulder; potholes; driving speed; road curvature; whether the road is winding or straight; road pitch (e.g., whether the road is steep or flat); traffic (e.g., degree of congestion, relative speed of other drivers); past driving habits of the driver (e.g., tendency of the driver to speed, brake hard, or other driving habits of the driver that indicate the driver should have a lower distraction threshold); driver experience (e.g., newly licensed driver, etc.); driver age (e.g., young, elderly); driver experience with the vehicle in operation (e.g., newly purchased, borrowed, rented car, etc.); date; time of operating the vehicle; roadway novelty (e.g., whether the driver is at a familiar area or new area); roadway construction; proximity to sensitive zones (e.g., a school, hospital, etc.); amount of time driving on a trip (e.g., first hour driving, tenth hour driving, etc.); pedestrian distance from the vehicle; and driver fatigue.

In some aspects, the context-aware intelligent cockpit can assume control of functions of the vehicle based on the distraction level. For example, when the driver distraction score exceeds the distraction threshold, the context-aware intelligent cockpit can turn on autonomous driving functions until the distracted driver score is reduced to below the distraction threshold. For example, the context-aware intelligent cockpit can turn on adaptive cruise control when the driver is distracted. In further aspects, the context-aware intelligent cockpit can adjust recommendations and actions based on driver responses to warnings. For example, the context-aware intelligent cockpit can determine response time of a driver based on an amount of time for the driver to respond to a warning. Based on the response time, the context-aware intelligent cockpit can determine to warn the driver faster and more often based on the driver response time.

In some aspects, the machine learning model or distraction algorithm for generating the driver distraction scores can be adjusted based on data associated with monitoring a plurality of drivers. For example, the context-aware intelligent cockpit can determine that distraction factors previously identified as distracting the driver do not reduce driver attention as first identified. The context-aware intelligent cockpit can use the data associated with monitoring the plurality of drivers to identify patterns and correlations of distraction factors and driver operation of the vehicle. The context-aware intelligent cockpit can add and remove distraction factors based on the data. In some aspects, the context-aware intelligent cockpit can adjust weights associated with distraction factors based on the data.

Various aspects of the present disclosure will be described with respect to the figures.

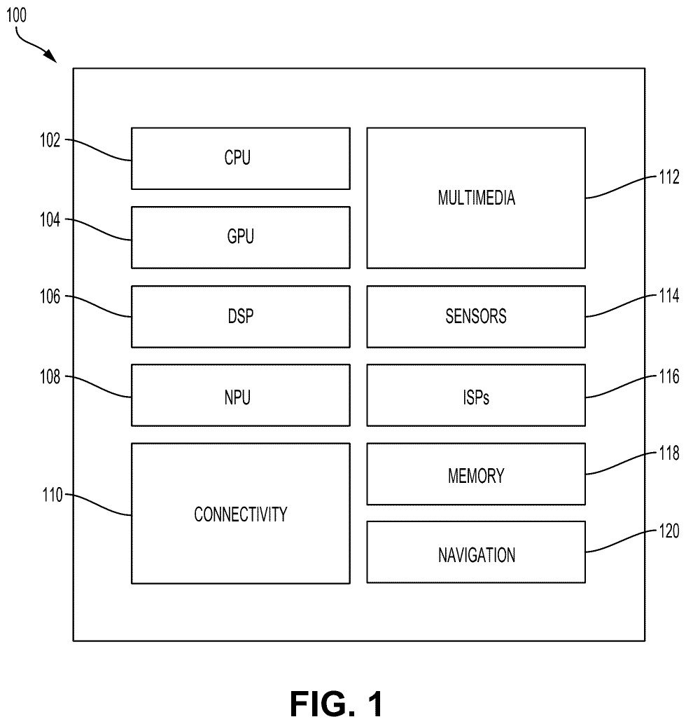

FIG. 1 illustrates an example implementation of a system-on-a-chip (SOC) 100, which may include a central processing unit (CPU) 102 or a multi-core CPU configured to provide a context-aware intelligent cockpit of a vehicle (e.g., processing data from various sensors, generating driver distraction scores, etc.). Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory (e.g., at least one memory coupled to the CPU or other component) associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, GPU 104, or a general-purpose processor. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor (or CPU 102) can include code to receive a large language model (LLM), the LLM having multiple layers, each layer having a set of parameters. The instructions loaded into the general-purpose processor, or CPU 102, can also include code identify a subset of the parameters to fine-tune for a downstream task based on a score function. The instructions loaded into the general-purpose processor, or CPU 102, can additionally include code apply an adapter to the identified subset of the parameters to fine-tune. The instructions loaded into the general-purpose processor, or CPU 102, can further include code fine-tune only the identified subset of the parameters.

Deep learning architectures can perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture can learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures can perform especially well when applied to problems that have a natural hierarchical structure. For example, the classification of motorized vehicles can benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

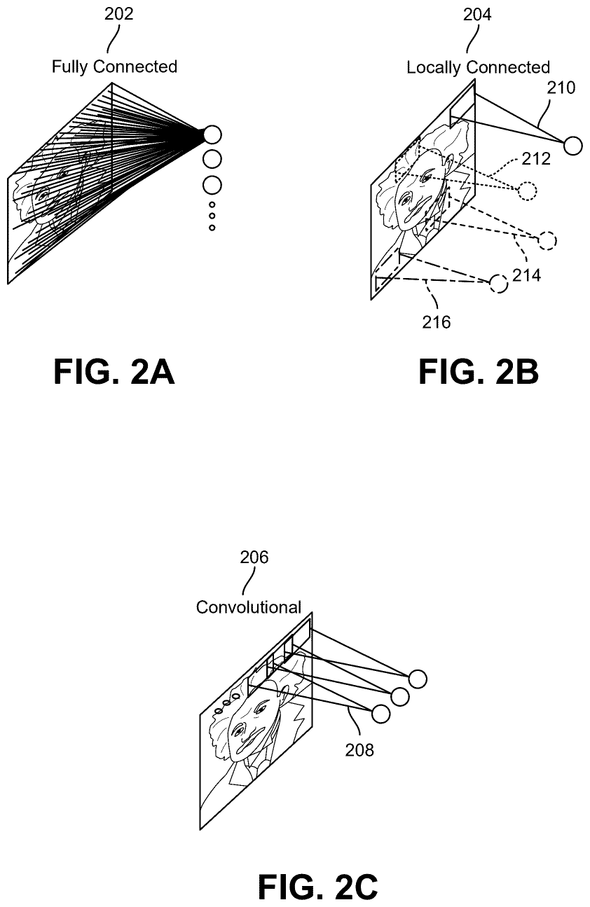

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

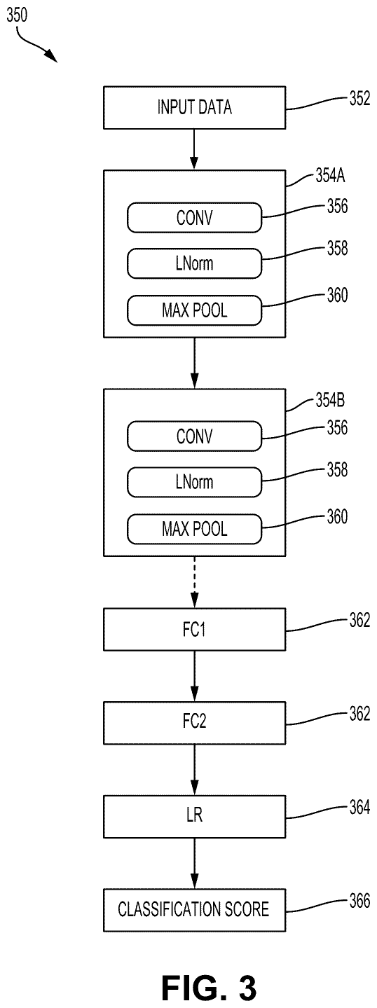

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

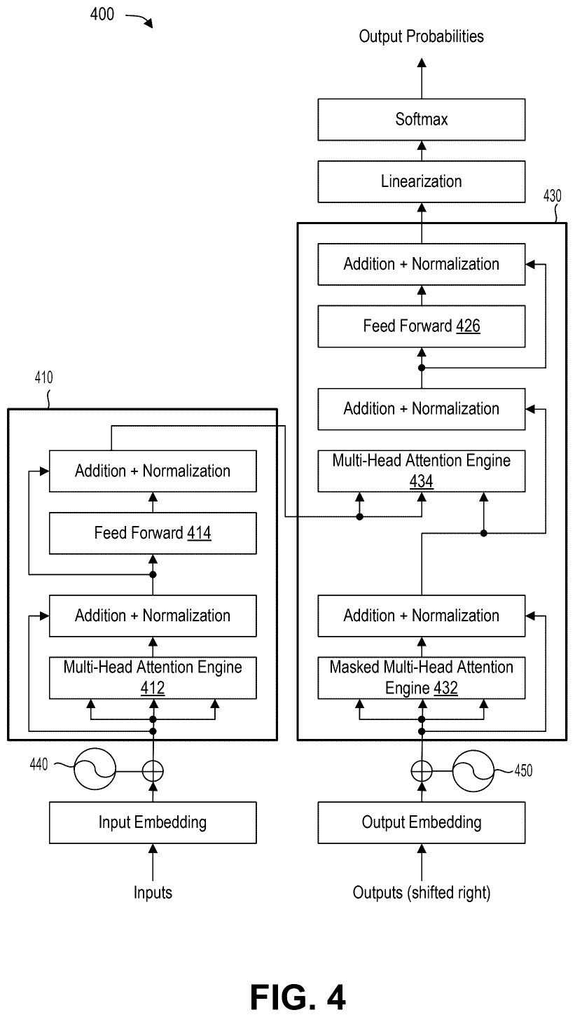

FIG. 4 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. A transformer 400 reduces the operations of learning dependencies by using an encoder 410 and a decoder 430 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 410 is composed of a stack of six identical layers and each layer has two sub-layers. The first sub-layer is a multi-head self-attention engine 412, and the second sub-layer is a fully connected feed-forward network 414. A residual connection connects around each of the sub-layers followed by normalization.

In this example transformer 400, the decoder 430 is also composed of a stack of six 6 identical layers. The decoder also includes a masked multi-head self-attention engine 432, a multi-head attention engine 434 over the output of the encoder 410, and a fully connected feed-forward network 426. Each layer includes a residual connection (not shown) around the layer, which is followed by layer normalization. The masked multi-head self-attention engine 432 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 440 to encode positions because the model does not contain recurrence and convolution and relative or absolute position of the tokens is needed. In the transformer 400, the positional encodings are added to the input embeddings at the bottom layer of the encoder 410 and the decoder 430. The positional encodings are summed with the embeddings because the positional encodings and embeddings have the same dimensions. A corresponding position decoder 450 is configured to decode the positions of the embeddings for the decoder 430.

In some aspects, the transformer 400 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 400 can process input sequences of variable length, making it well-suited for natural language processing tasks where input lengths can vary greatly. Additionally, the self-attention mechanism allows the transformer 400 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

In some aspects, the context-aware intelligent cockpit can use large language models to generate prompts for users to apply driver attention to the road. For example, the large language model can be trained to generate prompts based on past driver behavior. For example, the large language model can adjust word usage, tone, and emphasis based on driver response to past prompts. In one such example, a first driver can prefer a more polite prompt such as “Please focus on driving. Heavy traffic detected.” In another example, a second driver can prefer a more detailed and direct prompt such as “Focus on the road now! The traffic is heavy, the road is winding, and you're interacting with the display too much!”

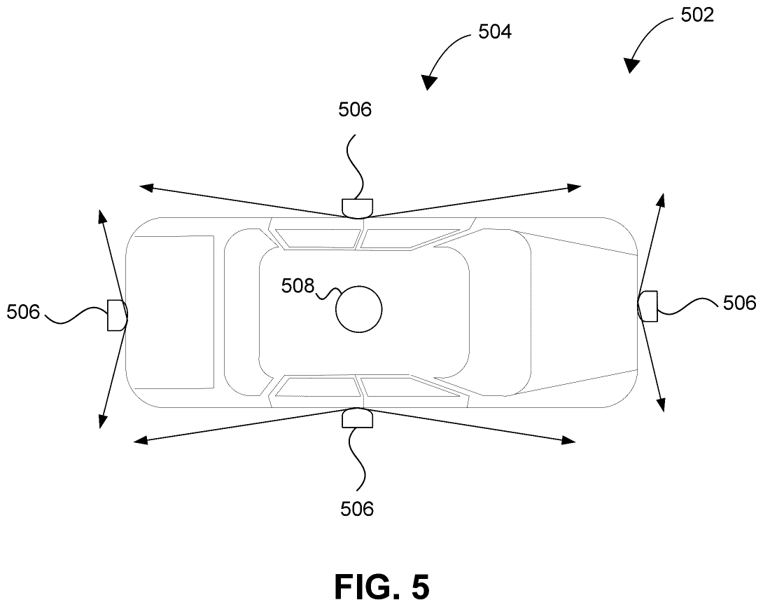

FIG. 5 is a diagram illustrating an example of a vehicle (e.g., an autonomous or semi-autonomous vehicle) 502 with a sensor suite 504. The source sensor suite 504 is shown to include four cameras 506 and one Light Detection and Ranging (LIDAR) sensor 508. Each of the cameras 506 may be a surround view (SV) camera or a fisheye camera, for example, with a wide (e.g., nearly 180 degree) field of view. The LIDAR sensor 508 may be a 64-layer LIDAR sensor. In one or more examples, the source sensor suite 504 of the source vehicle 502 may include a greater or lower number of cameras 506 and/or LIDAR sensors 508, than as shown in FIG. 5.

Collectively, the source sensor suite 504 may have certain intrinsic parameters (e.g., focal lengths of the cameras 506, optical centers of the cameras 506, skew coefficients of the cameras 506, frame-capture rates of the cameras 506, scan patterns of the LIDAR sensor 508, and/or intensity channels of the LIDAR sensor 508) and certain extrinsic parameters (e.g., positions of the cameras 506 and the LIDAR sensor 508 on source vehicle 502).

Data from at least a portion of the source sensor suite 504 can be used by the context-aware intelligent cockpit system to determine various actions to perform based on how distracted a driver is, drive conditions, vehicle conditions, and driving conditions.

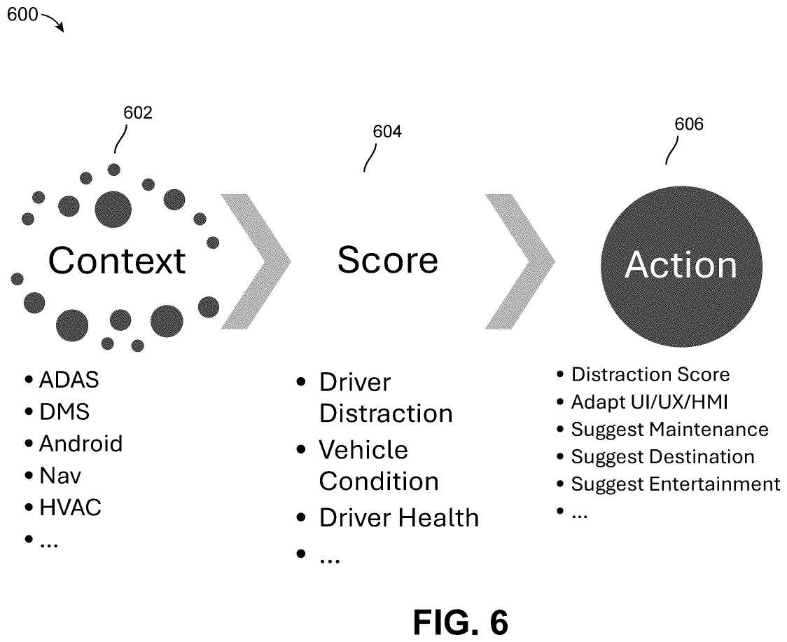

FIG. 6 is a block diagram illustrating an example of a process for providing an intelligent cockpit system 600. The intelligent cockpit system 600 includes a context engine 602, a scoring engine 604, and an action engine 606.

The context engine 602 receives input data (e.g., sensor data and other data) from various sensors and applications associated with a vehicle. In some examples, the context engine 602 can receive input data from subsystems of the vehicle. For example, the context engine 602 can receive sensor data from cameras, microphones, RADAR sensors, LIDAR sensors, etc. of the vehicle. In some examples, the context engine 602 can receive input data from an advanced driver assistance system (ADAS) and a driver monitoring system (DMS) associated with the vehicle.

In further examples, the context engine 602 can receive input data from an electronic device (e.g., a smartphone, computer, tablet) associated with a driver, also referred to as the user. For example, the context engine 602 can receive input data from a smartphone of the driver, such as input data indicating the driver is operating the smartphone while driving the vehicle. In some examples, the context engine 602 can receive input data identifying the driver. For example, the vehicle or smartphone can include driver profiles including data associated with preferences and driving habits of the driver. In some examples, the context engine 602 can filter irrelevant data (e.g., data not associated with whether the driver is distracted).

The scoring engine 604 can receive context data from the context engine 602. The scoring engine 604 can generate a distracted driver score based on the input data (also referred to as context data) using a distraction algorithm. In some examples, the scoring engine 604 generates the distracted driver score using a machine learning model.

In some examples, the driver distraction score can be generated using input data captured on a rolling time window. For example, the driver distraction score can be generated using input data from a predetermined rolling time period. In some examples, the frequency of which the scoring engine 604 generates the distracted driver score can be adjust based on the speed of the vehicle or environmental conditions. For example, the distracted driver score can be generated more often (e.g., at a higher frequency) when the driver is driving over seventy miles per hour, compared to when the driver is driving below twenty miles per hour.

The distraction algorithm can be based on various distraction factors associated with the input data. For example, distraction factors can include the driver: looking away from the road, the driver interacting with the car's display, eating, drinking, smoking, engaging in conversation with a passenger, engaging in conversation on a phone, holding and interacting with a handheld device, listening to a podcast or audio book, and engaging with a voice assistant. In some examples, the distraction factors can include a noise level within the vehicle.

In some examples, the scoring engine 604 can generate additional scores associated with the driver condition score (e.g., a score representing the well-being of the driver), drive condition score (e.g., a score representing how well the driver is performing when operating the vehicle), and a vehicle condition score (e.g., a score representing the operability of the vehicle such as maintenance issues).

The action engine 606 can compare the distracted driver score to a distraction threshold and determine to perform an action based on whether the distracted driver score exceeds the distraction threshold. The distraction threshold is predetermined threshold value representing a level of distraction unsafe for operating a vehicle. When the distraction score exceeds the distraction threshold, the action engine 606 determines to perform an action to redirect driver attention to operating the vehicle. The action engine 606 determines to perform actions to lower the driver distraction score to a level below the distraction threshold. In some examples, the action engine 606 can communicate with applications, functions, and subsystems associated with the vehicle to perform the actions.

In some examples, the distraction threshold is adjustable based on the environment in which the vehicle is operating. The action engine 606 or scoring engine 604 can adjust the distraction threshold based on various threshold factors. The threshold factors can include sensor data associated with the driver, the vehicle, the operation of the vehicle, and the environment in which the vehicle is operating. For example, various threshold factors can include: weather conditions; glare; road conditions; obstacles on the road; driving speed; road curvature; road pitch; traffic; past driving habits of the driver; driver experience; driver age; driver experience with the vehicle in operation; whether the driver is familiar with an area; roadway construction; proximity to sensitive zones (e.g., a school, hospital, etc.); an amount of time driving on a trip (e.g., first hour driving, tenth hour driving, etc.); and driver fatigue.

For example, the action engine 606 can lower the distraction threshold when driving in adverse weather conditions. In such an example, a lower driver distraction score can trigger the action engine 606 to perform an action that may in clear weather conditions have not otherwise been triggered. The action engine 606 can determine to perform various actions. In some examples, the action engine 606 can determine thresholds associated with the additional scores generated by the scoring engine 604 (e.g., the driver condition score, the drive condition score, and the vehicle condition score). Further description of the actions performed by the action engine 606 or determined to be performed by the action engine 606 are provided in the description of FIG. 6.

In some examples, the action engine 606 can include multiple distraction thresholds. For example, the multiple distraction thresholds can be associated with different actions. In one such example, when the distraction score exceeds a first distraction threshold, the action engine 606 can determine to generate a warning to the driver. When the distraction score exceeds a second distraction threshold greater than the first distraction threshold, the action engine 606 can determine to assume control of autonomous operation. For example, the action engine 606 can determine to activate adaptive cruise control based on the distraction score exceeding the second distraction threshold.

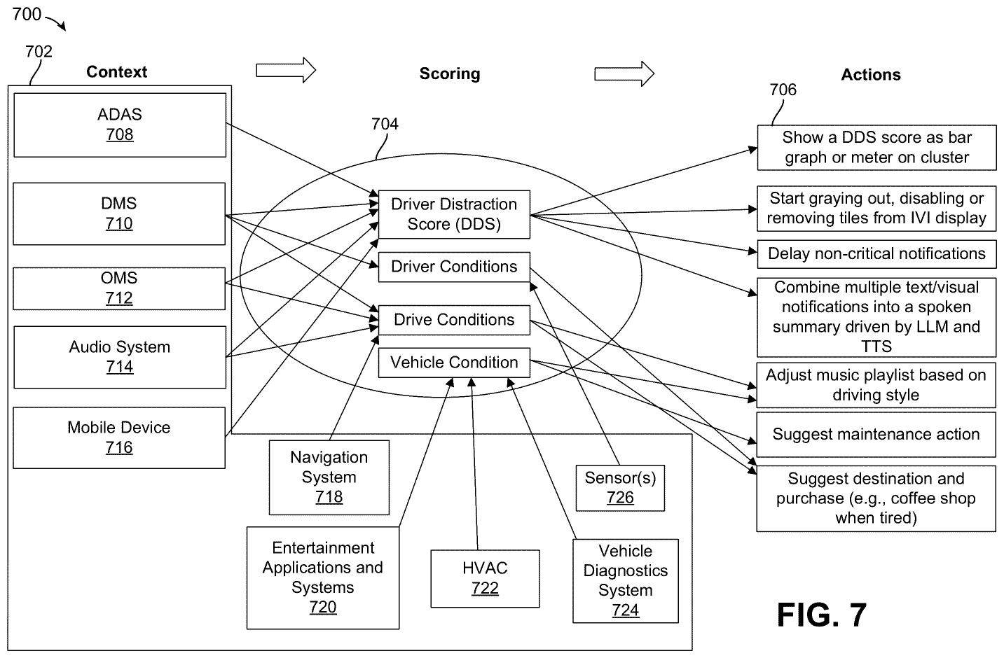

FIG. 7 is a block diagram illustrating an example context-aware intelligent cockpit system 700 of a vehicle. The context-aware intelligent cockpit system 700 includes a context engine 702, a scoring engine 704, and an action engine 706.

The context engine 702 receives input data from various applications, sensors, and subsystems of a vehicle including the context-aware intelligent cockpit system 700. For example, the context engine 702 can receive context data from various systems and applications such an advanced driver assistance system (ADAS) 708, a driver monitoring system (DMS) 710, occupant monitoring system (OMS) 712, audio systems 714, a mobile device 716 (e.g., a mobile phone, a tablet computer, a wearable such as a smartwatch, etc.), navigation system 718 (e.g., GPS, HD maps, etc.), entertainment applications and systems 720 (e.g., music streaming applications, stereo system, radio, etc.), air conditioning systems 722 (e.g., a Heating, Ventilation, and Air Conditioning (HVAC) system), vehicle diagnostic systems 724 (e.g., on-board diagnostics OBD), and various sensors 726 associated with the vehicle (e.g., the sensor suite described in the description of FIG. 4).

In some cases, the context data from the ADAS 708 can include a number of vehicles in proximity to the vehicle (e.g., within a threshold distance to the vehicle, such as 5 meters, 10 meters, etc.), information related to pedestrians in proximity to the vehicle, a curvature of a road (e.g., a road on which the vehicle is traveling, an upcoming road, or one or more roads along a route of the vehicle), a number of lanes (e.g., on a road on which the vehicle is traveling), traffic information (e.g., a level of traffic), driving style of an operator or driver of the vehicle (e.g., aggressive, sport, relaxed, etc.), and/or other information.

The context data from the DMS 710 can include a number of detected distractions of a operator or driver of the vehicle. For instance, the DMS 710 can keep track of a number of distraction glances away from the road during a period of time (e.g., the last 3 minutes, 5 minutes, 10 minutes, 30 minutes, etc.). In some cases, the DMS 710 can receive images or frames (e.g., a video or stream of images) from one or more cameras inside the vehicle. The DMS 710 can determine, from the images or frames, when a user looks away from a forward-looking position (e.g., when a user glances at a mobile device, at an infotainment system (e.g., an in-vehicle infotainment (IVI) system) of the vehicle, in a backseat of the vehicle such as to talk with a passenger, etc.).

The context data from the OMS 712 can include a number of passengers in the vehicle. The OMS 712 can determine and in some cases monitor the number of passengers in the vehicle. The audio system 714 can determine an ambient sound level in the vehicle (e.g., by subtracting the sound from music or other media playing by a media system of the vehicle) and/or a sound level of media playing by a media system of the vehicle, and provide the ambient sound level and/or media sound level as context data.

The context data from the mobile device 716 can include a number of interactions with an infotainment system (e.g., an IVI system) of the vehicle, a time of day, whether it is a weekday or weekend, pending notifications (e.g., email, text messages such as short message service (SMS) messages, system messages, etc.), and/or other information or data.

The context data from the navigation system 718 may include or be based on GPS data (or GNSS data), HD map data, and/or other navigation based data. For example, the context data from the navigation system 718 can be determined using or based on GPS/GNSS and/or HD map data and can include a distance from a particular destination, whether the vehicle is on a highway or on a local road, traffic conditions, etc.

The context data from the entertainment applications and systems 720 (e.g., music streaming applications, stereo system, radio, etc.) can include a genre of audio being played (e.g., news, podcast, ebook, rock, classical, sports radio, etc.), a source of the audio (e.g., satellite, broadcast, streaming, storage/local, etc.), and/or other information or data.

The context data from the air conditioning systems 722 (e.g., a Heating, Ventilation, and Air Conditioning (HVAC) system) can include a temperature of the vehicle (or a temperature per zone of the vehicle, such as front of the vehicle, middle of the vehicle, back of the vehicle, a right side of the vehicle, a left side of the vehicle, etc.), an air conditioner state (e.g., whether the air conditioner is on or off), a seat warmer state (e.g., whether one or more seat warmers are on or off), a seat air conditioner state (e.g., whether one or more seat air conditioners are on or off), and/or other information or data.

The context data from the vehicle diagnostic systems 724 (e.g., on-board diagnostics OBD) DTC codes, predictive maintenance information for the vehicle (e.g., a number of miles or time when an oil change, multipoint inspection, or other service is needed, a tire level of the vehicle, an impairment of the vehicle, etc.), a battery or charge level of the vehicle (e.g., for an electric vehicle), a fuel level of the vehicle, etc.

The sensors 726 associated with the vehicle may include one or more cameras, LiDAR sensors, radar sensors, etc. For instance, the sensors 726 may include the sensor suite described in the description of FIG. 4. The context data from the sensors 726 can include biometric data (e.g., face identification or recognition data, fingerprint data, weight information, etc.), predictive maintenance information for the vehicle (e.g., a tire level of the vehicle, etc.)

The context engine 702 receives the input data and can organize the input data based on relevance to various conditions of the driver and vehicle. For example, the input data associated with the vehicle diagnostic systems can be relevant to a condition of the vehicle, but not relevant to a distraction level of the driver.

The scoring engine 704 generates various scores associated with the driver. For example, the scoring engine 704 can generate a driver distraction score, a driver condition, a drive condition, and a vehicle condition. The driver distraction score can represent an amount of distraction the driver is exposed to while operating the vehicle. For example, the scoring engine 704 can use input data (e.g., context data) from the ADAS, DMS, OMS, audio system, and a smartphone of the driver to generate a driver distraction score.

In another example, the scoring engine 704 can generate a driver condition score based on input data from the DMS and various sensors. In some examples, the driver condition score is a determination of the condition of the driver instead of or in addition to being a score. For example, the driver condition can be a determination of whether the driver is fatigued or incapacitated.

In a further example, the scoring engine 704 can generate a drive condition score. In some examples, the drive condition score is a determination of driving conditions instead of or in addition to being a score. For example, the scoring engine 704 can determine how well the driver is performing when driving the vehicle. For example, the scoring engine 704 can use input data from the DMS, OMS, audio system, and navigation system to determine a driving style of the driver and how well the driver is performing when driving the vehicle (e.g., hard braking, following too closely, speeding, etc.).

In another example, the scoring engine can generate a vehicle condition score. In some examples, the vehicle condition score is a determination of the condition of the vehicle (e.g., whether the vehicle is maintained and operating appropriately) instead of or in addition to being a score. For example, the scoring engine 704 can use input data from entertainment applications and systems, A/C systems, and diagnostics systems to determine whether the vehicle is operating appropriately. For example, the scoring engine 704 can use information from the diagnostics systems to determine whether the vehicle is behind on maintenance, is low on oil, etc. In another example, the scoring engine 704 can use input data from the entertainment applications and systems to determine whether a speaker is broken and can use input data from the A/C to determine whether the vehicle has a refrigerant leak.

The action engine 706 can determine whether to perform various actions based on the driver distraction score, the driver condition, the drive condition, and the vehicle condition. The action engine 706 can determine to perform the various actions based on whether the driver distraction score exceeds a predetermined distraction threshold. In further examples, the action engine 706 can determine to perform the various actions based on determinations of the scoring engine 704 associated with the driver condition, drive condition, and the vehicle condition.

For example, the action engine 706 can determine to display the driver distraction score as a bar graph or meter on a display of the vehicle. When the driver distraction score exceeds a distraction threshold, the action engine 706 can determine to adjust a user interface of the vehicle to restrict functions or applications based on the driver distraction score. For example, the action engine 706 can determine to gray out, disable, or otherwise remove artifacts from the user interface associated with restricted functions or applications.

In another example, the action engine 706 can determine to delay notifications output on the display. For example, when the driver distraction score exceeds the distraction threshold, the action engine 706 can determine to delay text messages or phone calls. In some examples, the action engine 706 can determine to generate warnings or other notifications to the driver. For example, the action engine 706 can include a generative machine learning model (e.g., a large language model LLM) and text to speech (TTS) model to generate descriptions (e.g., a summary) of driver operation of the vehicle. The text to speech model can output the description as audio. For example, the description can include recommendations to apply more attention to the road or inform the driver of how often the driver looks away from the road.

In further examples, the action engine 706 can use the driver condition, drive condition, and vehicle condition to determine various actions to perform. For example, the action engine 706 can determine to adjust a music playlist based on drive conditions of a driver. For example, when the driver is driving on an interstate at 70 miles per hour, the action engine 706 can recommend music with a faster rhythm, such as pop or rock. When the driver is driving on a surface street at 30 miles per hour, the action engine 706 can recommend music with a slower rhythm, such as r&b or ballads. In some examples, when the drive condition indicates the driver has been cut off by another driver and is demonstrating anxiety, the action engine 706 can adjust the music playlist to play soothing music to calm the driver.

In another example, the action engine 706 can use vehicle condition to determine whether to schedule a maintenance action such as an oil change or tire rotation. In further examples, the action engine 706 can use the drive condition or driver condition to determine whether to order a cup of coffee for the driver or suggest a destination such as a hotel for the driver to rest when the driver condition indicates the driver is fatigued.

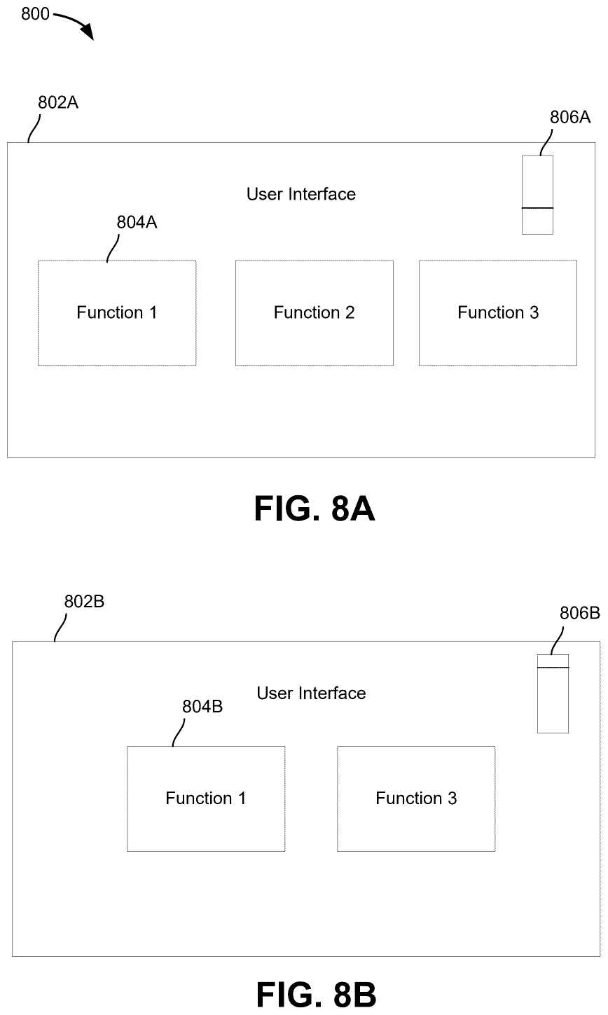

FIG. 8A and FIG. 8B are example block diagrams 800 of a first user interface 802A with a first driver distraction score 806A below a distraction threshold and a second user interface 802B with a second driver distraction score 806B below the distraction threshold. For example, the first user interface 802A includes a first plurality of functions 804A. Drivers can select individual artifacts to perform various actions. For example, function 1 can be an artifact associated with controlling a GPS, function 2 can be an artifact associated with controlling a radio, and function 3 can be associated with controlling A/C of the vehicle.

FIG. 8B illustrates changes to the first user interface 802A when the driver distraction score exceeds the distraction threshold. For example, FIG. 8B includes the second user interface 802B and a second driver distraction score 806B. By way of example, the second driver distraction score 806B exceeds the distraction threshold. The second user interface 802B includes a second plurality of functions 804B. The second plurality of functions 804B includes fewer functions than the first plurality of functions 804A. For example, the second user interface 802B includes restrictions to access to function 2 based on the driver distraction score exceeding the distraction threshold. When the driver distraction score is reduced to below the distraction threshold, the second user interface 802B can revert to the first user interface 802A to restore driver access to function 2.

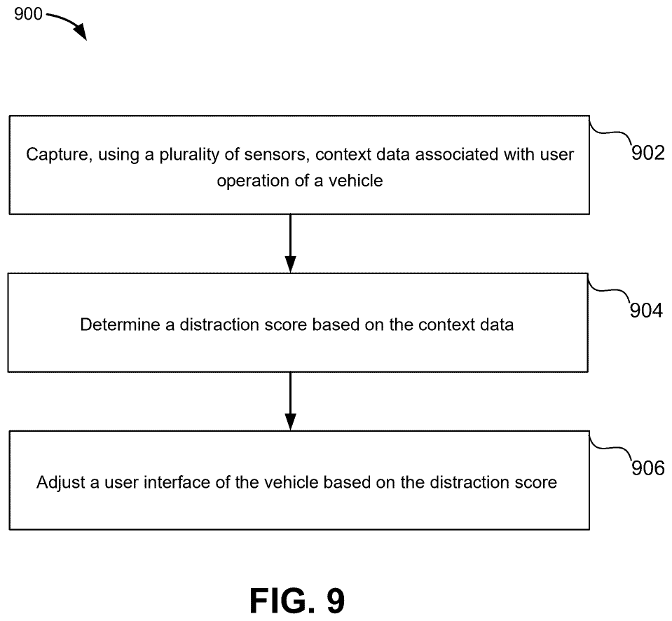

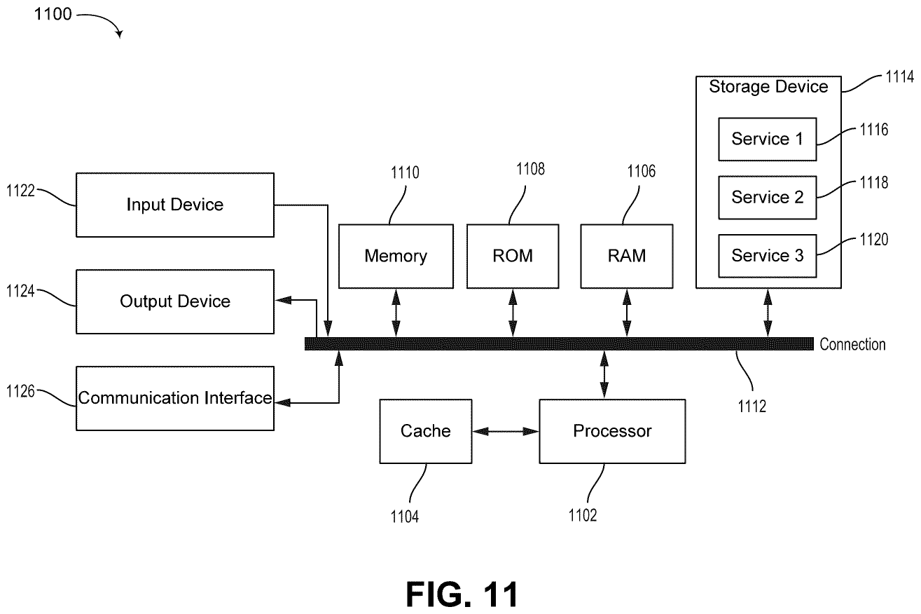

FIG. 9 is a flow diagram illustrating an example of a process 900 for generating a driver distraction score of a context-aware intelligent cockpit. The process 900 can be performed by a computing device (e.g., SOC 100 of FIG. 1, computing device or computing device architecture 1100 of FIG. 11, etc.) or by a component or system (e.g., the neural networks of FIGS. 2A-2C, a chipset, one or more processors central processing units (CPUs), digital signal processors (DSPs), graphics processing units (GPUs), any other type of processor(s), any combination thereof, or other component or system) of the computing device. The operations of the process 900 can be implemente as software components that are executed and run on one or more processors (e.g., processor 1102 of FIG. 11 or other processor(s)) of the computing device. Further, the transmission and reception of signals by the computing device in the process 900 can be enabled, for example, by one or more antennas and/or one or more transceivers (e.g., wireless transceiver(s)).

At block 902, the computing device (or component thereof) can capture context data associated with user operation of a vehicle. For example, the computing device can be part of a vehicle (e.g., vehicle 502 of FIG. 5). The computing device can use a plurality of sensors (e.g., the sensor suite 504 of FIG. 5) to capture context data. For example, the plurality of sensors can include cameras to capture context data associated with traffic or obstacles on a road. The plurality of sensors can include microphones to capture context data associated with a noise level in a cockpit of the vehicle. In some examples, the computing device can receive the context data from another device, such as a smartphone. For example, a driver can have a driver profile associated with the smartphone of the driver. When the driver pairs his or her smartphone with the vehicle or the computing device, the computing device can receive a driver profile including driver preferences and driver history.

In further examples, the context data includes a count of user interactions with the user interface over a predetermined period of time. For example, the context data can be associated with user interactions with a touch screen during a predetermined period of time (e.g., 15 seconds). In another example, the context data includes data can include data associated with an environment in which the vehicle is operating such as an amount of traffic on a road where the vehicle is located, pedestrian distance from the vehicle, curvature of the road, and a number of lanes of the road. In another example, the context data includes data associated with a number of passengers in the vehicle. In a further example, the context data can include data associated with a sound level within the vehicle. In another example, the context data includes data associated with a date and time of operation of the vehicle.

At block 904, the computing device (or component thereof) can determine a distraction score based on the context data. The computing device can use a scoring engine (e.g., the scoring engine 604 of FIG. 6) to generate the distraction score (also referred to as the driver distraction score). The scoring engine can use a distraction algorithm to generate the distraction score. The distraction score can be based on various distraction factors associated with the context data. The scoring engine can apply the context data to the distraction algorithm to generate the distraction score. In some examples, the scoring engine is a machine learning model, such as the machine learning models of FIG. 2A-2C, FIG. 3, and FIG. 4.

At block 906, the computing device (or component thereof) can adjust a user interface of the vehicle based on the distraction score. Adjustments to the user interface can include adjusting the size of elements of the user interface, adjusting the position of elements of the user interface, or removing elements of the user interface. For example, the computing device can disable features of the vehicle (e.g., a radio, a touchscreen, a sound system, etc.) by graying out, removing, or blocking elements of the user interface associated with the disabled features. In further examples, adjusting the user interface can include delaying display of notifications on the user interface based on the distraction score.

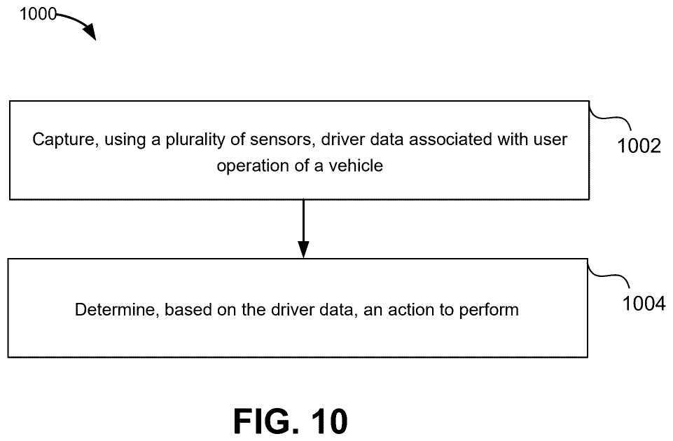

FIG. 10 is a flow diagram illustrating an example of a process 1000 for generating a driver distraction score of a context-aware intelligent cockpit. The process 1000 can be performed by a computing device (e.g., SOC 100 of FIG. 1, computing device or computing device architecture 1100 of FIG. 11, etc.) or by a component or system (e.g., the neural networks of FIGS. 2A-2C, a chipset, one or more processors central processing units (CPUs), digital signal processors (DSPs), graphics processing units (GPUs), any other type of processor(s), any combination thereof, or other component or system) of the computing device. The operations of the process 1000 can be implemented as software components that are executed and run on one or more processors (e.g., processor 1102 of FIG. 11 or other processor(s)) of the computing device. Further, the transmission and reception of signals by the computing device in the process 1000 can be enabled, for example, by one or more antennas and/or one or more transceivers (e.g., wireless transceiver(s)).

At block 1002, the computing device (or component thereof) can capture driver data associated with user operation of a vehicle. In some examples, the computing device can be part of a vehicle (e.g., vehicle 502 of FIG. 5). The computing device can use a plurality of sensors (e.g., the sensor suite 504 of FIG. 5) to capture the driver data. For example, the plurality of sensors can include cameras to capture driver data such as actions performed by the driver within the cockpit of the vehicle (e.g., driver interactions with a smartphone, conversations between the driver and a passenger, driver taking his or her eyes off the road, etc.). In further examples, the driver data can include data associated with the vehicle (e.g., whether the vehicle is past due for an oil change or tire rotation, whether the vehicle has low tire pressure, etc.). In some examples, the computing device can receive the driver data from another device, such as a smartphone. For example, a driver can have a driver profile associated with the smartphone of the driver. When the driver pairs his or her smartphone with the vehicle or the computing device, the computing device can receive a driver profile including driver preferences and driver history.

At block 1004, the computing device (or component thereof) can determine an action to perform based on the driver data. For example, the action can be adjustments to a music playlist. In such an example, adjustments to the music playlist can include playing an upbeat song to help the driver stay awake. In another example, adjustments to the music playlist can include playing a soothing song when the driver is determined to be stressed based on the driver data. In some examples, the action can include generating a recommendation to perform maintenance on the vehicle (e.g., recommendation to check oil, add windshield wiper fluid, etc.).

In further examples, the action can include automatic placement of an order for a purchase. For example, the driver data can indicate the driver is fatigued. The computing device (or component thereof) can place the order for a cup of coffee based on the driver data. In another example, the action can include a recommendation to travel to a destination. For example, when the driver data indicates the driver is fatigued, the computing device can recommend the driver travel to a hotel.

FIG. 11 illustrates an example computing-device architecture 1100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1100 may include, implement, or be included in any or all of the devices, modules, or systems described herein. Additionally or alternatively, computing-device architecture 1100 may be configured to perform process 900, process 1000, and/or other process described herein.

The components of computing-device architecture 1100 are shown in electrical communication with each other using connection 1112, such as a bus. The example computing-device architecture 1100 includes a processing unit (CPU or processor) 1102 and computing device connection 1112 that couples various computing device components including computing device memory 1110, such as read only memory (ROM) 1108 and random-access memory (RAM) 1106, to processor 1102.

Computing-device architecture 1100 can include a cache of high-speed memory connected directly with, in close proximity to, or integrated as part of processor 1102. Computing-device architecture 1100 can copy data from memory 1110 and/or the storage device 1114 to cache 1104 for quick access by processor 1102. In this way, the cache can provide a performance boost that avoids processor 1102 delays while waiting for data. These and other modules can control or be configured to control processor 1102 to perform various actions. Other computing device memory 1110 may be available for use as well. Memory 1110 can include multiple different types of memory with different performance characteristics. Processor 1102 can include any general-purpose processor and a hardware or software service, such as service 1 1116, service 2 1118, and service 3 1120 stored in storage device 1114, configured to control processor 1102 as well as a special-purpose processor where software instructions are incorporated into the processor design. Processor 1102 may be a self-contained system, containing multiple cores or processors, a bus, memory controller, cache, etc. A multi-core processor may be symmetric or asymmetric.

To enable user interaction with the computing-device architecture 1100, input device 1122 can represent any number of input mechanisms, such as a microphone for speech, a touch-sensitive screen for gesture or graphical input, keyboard, mouse, motion input, speech and so forth. Output device 1124 can also be one or more of a number of output mechanisms known to those of skill in the art, such as a display, projector, television, speaker device, etc. In some instances, multimodal computing devices can enable a user to provide multiple types of input to communicate with computing-device architecture 1100. Communication interface 1126 can generally govern and manage the user input and computing device output. There is no restriction on operating on any particular hardware arrangement and therefore the basic features here may easily be substituted for improved hardware or firmware arrangements as they are developed.

Storage device 1114 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1106, read only memory (ROM) 1108, and hybrids thereof. Storage device 1114 can include services 1116, 1118, and 1120 for controlling processor 1102. Other hardware or software modules are contemplated. Storage device 1114 can be connected to the computing device connection 1112. In one aspect, a hardware module that performs a particular function can include the software component stored in a computer-readable medium in connection with the necessary hardware components, such as processor 1102, connection 1112, output device 1124, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1: An apparatus for context-aware driving assistance, the apparatus comprising: at least one memory; and at least one processor coupled to the at least one memory and configured to: capture, using a plurality of sensors, context data associated with user operation of a vehicle; determine a distraction score based on the context data; and adjust a user interface of the vehicle based on the distraction score.

Aspect 2: The apparatus of Aspect 1, wherein the context data includes a count of user interactions with the user interface over a predetermined period of time.

Aspect 3: The apparatus of any of Aspects 1 to 2, wherein the context data includes data associated with at least one of an amount of traffic on a road where the vehicle is located, pedestrian distance from the vehicle, curvature of the road, or a number of lanes of the road.

Aspect 4: The apparatus of any of Aspects 1 to 3, wherein the context data includes data associated with a number of passengers in the vehicle.

Aspect 5: The apparatus of any of Aspects 1 to 4, wherein the context data includes data associated with a sound level within the vehicle.

Aspect 6: The apparatus of any of Aspects 1 to 5, wherein the context data includes data associated with a date and time of operation of the vehicle.

Aspect 7: The apparatus of any of Aspects 1 to 6, wherein the at least one processor is configured to: disable features of the vehicle based on the distraction score.

Aspect 8: The apparatus of any of Aspects 1 to 7, wherein the at least one processor is configured to: delay notifications based on the distraction score.

Aspect 9: The apparatus of any of Aspects 1 to 8, wherein the at least one processor is configured to: determine the distraction score is greater than a first predetermined threshold; and generate, using a machine learning model, a summary of the user operation of the vehicle based on the distraction score being greater than the first predetermined threshold.

Aspect 10: The apparatus of any of Aspects 1 to 9, wherein the first predetermined threshold is adjustable based on the context data.

Aspect 11: The apparatus of any of Aspects 1 to 10, wherein the at least one processor is configured to: output the summary as audio.

Aspect 12: The apparatus of any of Aspects 1 to 11, wherein the machine learning model is a large language model (LLM) and text to speech model (TTS).

Aspect 13: The apparatus of Aspect 9, wherein the at least one processor is configured to: determine the distraction score is greater than a second predetermined threshold, wherein the second predetermined threshold is greater than the first predetermined threshold; and generate, using the machine learning model, the summary of the user operation of the vehicle based on the distraction score being greater than the second predetermined threshold, wherein the summary of the user operation includes an adjusted tone based on the distraction score being greater than the second predetermined threshold.

Aspect 14: An apparatus for context-aware driving assistance, the apparatus comprising: at least one memory; and at least one processor coupled to the at least one memory and configured to: capture, using a plurality of sensors, driver data associated with user operation of a vehicle; and determine, based on the driver data, an action to perform.

Aspect 15: The apparatus of Aspect 14, wherein the at least one processor is configured to perform the action.

Aspect 16: The apparatus of any of Aspects 14 to 15, wherein the action comprises adjustment of a music playlist.

Aspect 17: The apparatus of any of Aspects 14 to 16, wherein the action comprises generation of a recommendation to perform maintenance on the vehicle.

Aspect 18: The apparatus of any of Aspects 14 to 17, wherein the action comprises generation of a recommendation to travel to a destination.

Aspect 19: The apparatus of any of Aspects 14 to 18, wherein the action comprises automatic placement of an order for a purchase.

Aspect 20: The apparatus of any of Aspects 14 to 19, wherein the at least one processor is configured to: identify, based on biometric data captured by the plurality of sensors, an identity of a user of the vehicle; and determine the action to perform based on the identity of the user and the driver data.

Aspect 21: A method for context-aware driving assistance, the method comprising: capturing, using a plurality of sensors, context data associated with user operation of a vehicle; determining a distraction score based on the context data; and adjusting a user interface of the vehicle based on the distraction score.

Aspect 22: The method of Aspect 21, wherein the context data includes a count of user interactions with the user interface over a predetermined period of time.

Aspect 23: The method of any of Aspects 21 to 22, wherein the context data includes data associated with at least one of an amount of traffic on a road where the vehicle is located, pedestrian distance from the vehicle, curvature of the road, or a number of lanes of the road.

Aspect 24: The method of any of Aspects 21 to 23, wherein the context data includes data associated with a number of passengers in the vehicle.

Aspect 25: The method of any of Aspects 21 to 24, wherein the context data includes data associated with a sound level within the vehicle.

Aspect 26: The method of any of Aspects 21 to 25, wherein the context data includes data associated with a date and time of operation of the vehicle.

Aspect 27: The method of any of Aspects 21 to 26, further comprising: disabling features of the vehicle based on the distraction score.

Aspect 28: The method of any of Aspects 21 to 27, further comprising: delaying notifications based on the distraction score.

Aspect 29: The method of any of Aspects 21 to 28, further comprising: determining the distraction score is greater than a first predetermined threshold; and generating, using a machine learning model, a summary of the user operation of the vehicle based on the distraction score being greater than the first predetermined threshold.

Aspect 30: The method of any of Aspects 21 to 29, wherein the first predetermined threshold is adjustable based on the context data.

Aspect 31: The method of any of Aspects 21 to 30, further comprising: outputting the summary as audio.

Aspect 32: The method of any of Aspects 21 to 31, wherein the machine learning model is a large language model (LLM) and text to speech model (TTS).

Aspect 33: The method of Aspect 29, further comprising: determining the distraction score is greater than a second predetermined threshold, wherein the second predetermined threshold is greater than the first predetermined threshold; and generating, using the machine learning model, the summary of the user operation of the vehicle based on the distraction score being greater than the second predetermined threshold, wherein the summary of the user operation includes an adjusted tone based on the distraction score being greater than the second predetermined threshold.

Aspect 34: A method for context-aware driving assistance, the method comprising: capturing, using a plurality of sensors, driver data associated with user operation of a vehicle; and determining, based on the driver data, an action to perform.

Aspect 35: The method of Aspect 34, further comprising: performing the action.

Aspect 36: The method of any of Aspects 34 to 35, wherein the action comprises adjustment of a music playlist.

Aspect 37: The method of any of Aspects 34 to 36, wherein the action comprises generation of a recommendation to perform maintenance on the vehicle.

Aspect 38: The method of any of Aspects 34 to 37, wherein the action comprises generation of a recommendation to travel to a destination.

Aspect 39: The method of any of Aspects 34 to 38, wherein the action comprises automatic placement of an order for a purchase.

Aspect 40: The method of any of Aspects 34 to 39, further comprising: identifying, based on biometric data captured by the plurality of sensors, an identity of a user of the vehicle; and determining the action to perform based on the identity of the user and the driver data.

Aspect 41: An apparatus for enhancing a user interface is provided. The apparatus includes one or more means for performing operations according to any of Aspects 1 to 20.

Aspect 42: A non-transitory computer-readable medium is provided having stored thereon instructions that, when executed by at least one processor, cause the at least one processor to perform operations according to any of Aspects 21 to 40.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

What is claimed is:

1. An apparatus for context-aware driving assistance, the apparatus comprising:
at least one memory; and
at least one processor coupled to the at least one memory and configured to:
capture, using a plurality of sensors, context data associated with user operation of a vehicle;
determine a distraction score based on the context data; and
adjust a user interface of the vehicle based on the distraction score.

2. The apparatus of claim 1, wherein the context data includes a count of user interactions with the user interface over a predetermined period of time.

3. The apparatus of claim 1, wherein the context data includes data associated with at least one of an amount of traffic on a road where the vehicle is located, pedestrian distance from the vehicle, curvature of the road, or a number of lanes of the road.

4. The apparatus of claim 1, wherein the context data includes data associated with a number of passengers in the vehicle.

5. The apparatus of claim 1, wherein the context data includes data associated with a sound level within the vehicle.

6. The apparatus of claim 1, wherein the context data includes data associated with a date and time of operation of the vehicle.

7. The apparatus of claim 1, wherein the at least one processor is configured to:
disable features of the vehicle based on the distraction score.

8. The apparatus of claim 1, wherein the at least one processor is configured to:
delay notifications based on the distraction score.

9. The apparatus of claim 1, wherein the at least one processor is configured to:
determine the distraction score is greater than a first predetermined threshold; and
generate, using a machine learning model, a summary of the user operation of the vehicle based on the distraction score being greater than the first predetermined threshold.

10. The apparatus of claim 9, wherein the first predetermined threshold is adjustable based on the context data.

11. The apparatus of claim 9, wherein the at least one processor is configured to:
output the summary as audio.

12. The apparatus of claim 9, wherein the machine learning model is a large language model (LLM) and text to speech model (TTS).

13. The apparatus of claim 9, wherein the at least one processor is configured to:
determine the distraction score is greater than a second predetermined threshold, wherein the second predetermined threshold is greater than the first predetermined threshold; and
generate, using the machine learning model, the summary of the user operation of the vehicle based on the distraction score being greater than the second predetermined threshold, wherein the summary of the user operation includes an adjusted tone based on the distraction score being greater than the second predetermined threshold.

14. A method for context-aware driving assistance, the method comprising:
capturing, using a plurality of sensors, context data associated with user operation of a vehicle;
determining a distraction score based on the context data; and
adjusting a user interface of the vehicle based on the distraction score.

15. The method of claim 14, wherein the context data includes a count of user interactions with the user interface over a predetermined period of time.

16. The method of claim 14, wherein the context data includes data associated with at least one of an amount of traffic on a road where the vehicle is located, pedestrian distance from the vehicle, curvature of the road, or a number of lanes of the road.

17. The method of claim 14, wherein the context data includes data associated with a number of passengers in the vehicle.

18. The method of claim 14, wherein the context data includes data associated with a sound level within the vehicle.

19. The method of claim 14, wherein the context data includes data associated with a date and time of operation of the vehicle.

20. The method of claim 14, further comprising:
determining the distraction score is greater than a first predetermined threshold; and
generating, using a machine learning model, a summary of the user operation of the vehicle based on the distraction score being greater than the first predetermined threshold.
